(19) United States
(12) Patent Application Publication
(10) Pub. No.: US 2026/0039175 A1
(43) Pub. Date: Feb. 5, 2026

(54) DEVICE FOR TRANSMITTING ELECTRICAL CURRENT TO A ROTOR OF AN ELECTRIC MACHINE

(71) Applicant: Schaeffler Technologies AG & Co. KG, Herzogenaurach (DE)

(72) Inventors: Oliver Schnell, Veitsbronn (DE); Arben Haxhiu, Herzogenaurach (DE); David Lang, Bubenreuth (DE); Marcus Romeis, Leinburg (DE); Oliver Witter, Westhausen (DE); Stefan Dupke, Neuenmarkt (DE)

(73) Assignee: Schaeffler Technologies AG & Co. KG, Herzogenaurach (DE)

(21) Appl. No.: 19/286,268

(22) Filed: Jul. 31, 2025

(30) Foreign Application Priority Data
Jul. 31, 2024 (DE) 10 2024 121 809.6

(51) Int. Cl. H02K 13/00

(52) U.S. Cl. CPC H02K 13/003

(57) ABSTRACT

The disclosure relates to a device for transmitting electrical current to a rotor of an electric machine, having a group of sliding contacts each assigned to an electrical pole for transmitting current to a slip ring of the electric machine assigned to each such group. At least one separator is provided for separating electrically conductive particles from the coolant of a coolant system for cooling the sliding contacts.

### CROSS-REFERENCE TO RELATED APPLICATIONS

This application claims priority under 35 U.S.C. Section 119 of German Patent Application No. DE 10 2024 121 809.6 filed on Jul. 31, 2024, the disclosure of which is incorporated herein by reference.

### TECHNICAL FIELD

The disclosure relates to a device for transmitting electrical current to a rotor of an electric machine.

### BACKGROUND

DE 10 2021 122 065 B3 discloses a brush holder for holding at least two brushes for a sliding contact arrangement. The brush holder comprises an intermediate element which has a receptacle for a rotating shaft and a cooling channel extending inside.

A slip ring system for an electric machine is disclosed in US 2019/0 140 521. The slip ring system comprises slip rings arranged to rotate about a rotational axis for transmitting current to the electric machine and an impeller which surrounds the rotational axis and can be mounted so as to be rotationally fixed relative to the slip rings and is adapted to generate an air flow in a plane perpendicular to the shaft. Furthermore, a filter is provided that surrounds the impeller.

JP S56-27 882 U describes a fully-enclosed commutator with an impeller to suck in air from one side of the commutator and to feed the brush dust to a filter.

U.S. Pat. No. 5,361,012 A discloses an electric machine with a commutator and brushes. It further comprises high-dielectric fluids and means for continuously applying high-dielectric fluids to the brushes near the commutator while the machine is in operation.

### SUMMARY

The object of the disclosure is therefore to propose a device of the aforementioned type which ensures safe operation in a structurally simple and cost-effective manner and in particular avoids interference caused by electrical arcing at the sliding contacts and creepage currents between the electrical poles of the sliding contacts.

Thus, a device for transmitting electrical current to a rotor of an electric machine is proposed. The device comprises two groups of sliding contacts, each assigned to an electrical pole, for transmitting current to a slip ring of the electric machine assigned to each such group, and a coolant system for cooling the sliding contacts. In order to ensure safe operation in a structurally simple and cost-effective manner, at least one separator is provided for separating electrically conductive particles from the coolant of the coolant system. The separator is arranged in a design that is structurally simple and cost-effective to implement and effective in terms of dielectric strength and electrical insulation in the area of the coolant inlet of the coolant system. A filter is provided as a separator. The sliding contacts and the coolant system with liquid cooling and the coolant inlet are arranged on a base support.

This prevents an increase in the electrical conductivity of the coolant due to electrically conductive wear particles entering the coolant, particularly at the sliding contacts. Accordingly, electrical arcing between the sliding contacts and the respective slip ring can be prevented, in particular by coolant escaping through leaks or, for example, by spray cooling. In addition, creepage currents between the electrical poles of the sliding contacts and the resulting weakening of the magnetic field generated in the rotor windings can be avoided.

It is also conceivable to arrange the separator at another location in the coolant system, in particular immediately before the coolant outlet for spray cooling. It is also possible to arrange a plurality of separators in the coolant system.

A further simplified and particularly effective design can be achieved if a filter is provided as a separator.

The filter can be pressed into a coolant inlet nozzle of the coolant system for fastening with a filter holder.

Alternatively, depending on the operating conditions, a sieve can also be provided as a separator.

Oil can be provided as a coolant, which is also a good electrical insulator.

In an example embodiment, the filter can have at least one additional filter surface aligned transversely to the flow direction of the coolant in addition to at least one filter surface aligned in the flow direction. This increases the filter surface and enables the air to flow through the filter transversely to the flow direction. This can, in particular, reduce the pressure loss at the filter while maintaining the same throughput or increase the throughput while maintaining the same pressure loss. “Transverse” here means a direction perpendicular to the flow direction or at any angle to it.

Two additional filter surfaces can be provided, which are aligned transversely to the flow direction and are arranged in a V-shape with the closed V-side facing in the flow direction.

In an example embodiment, the filter is tapered towards the outlet end. This provides more space for the coolant escaping from the filter transversely to the flow direction, so that the pressure loss at the filter in particular can be further reduced.

In an example embodiment, a filter fabric is provided as the separator.

The filter fabric can be fastened directly to a coolant inlet nozzle of the coolant system, thereby avoiding the need for additional components, in particular a filter holder.

A simple fastening of the filter fabric in the coolant inlet nozzle can be achieved by ultrasonic or laser welding.

Plastic can be utilized as the material for the filter holder, which makes it particularly easy and cost-effective to adapt to the installation conditions, in particular by plastic injection molding.

It is possible that the filter holder is designed with an annular fastening portion made of metal, in particular brass, for coolant-tight pressing into the coolant inlet nozzle. It is also conceivable to make the fastening portion conical, at least in sections.

In an example embodiment, plastic is provided as the material for the coolant inlet nozzle.

In an example embodiment, the coolant system with the coolant inlet is arranged on a base support which is designed with a central through-opening for the passage of a rotor shaft of the electric machine and which carries a contact carrier with the sliding contacts fastened thereto on the sides facing away from one another.

In an example embodiment, the proposed device forms a pre-assembled modular unit which, thanks to the design of the base support, can be easily adapted to the installation conditions, in particular on the rotor shaft of the electric machine. This is particularly true if the base support is manufactured using plastic injection molding and can therefore be easily and cost-effectively adapted to any shape while being weight-saving.

Consequently, the proposed device can be manufactured as a prefabricated module with flexible design and construction for, in particular, different rotor shafts as a standardized, cost-saving design with identical or largely identical and few components in particularly cost-effective series production. This applies in particular to the contact carriers with the sliding contacts.

The proposed fluid-cooled device can be used particularly advantageously for transmitting electrical current to a rotor of a separately excited synchronous electric machine.

### BRIEF DESCRIPTION OF THE DRAWINGS

Further claimed features of the invention result from the following description and from the figures, on the basis of which the present invention is explained in more detail. In the drawings:

FIG. 1 shows a device according to the invention for transmitting electrical current to a rotor of an electric machine in a side view in a first embodiment;

FIG. 2 shows the device in a sectional view along the line A-A of FIG. 1;

FIG. 3 shows an enlarged section from FIG. 2;

FIG. 4 shows a perspective side view of the device from FIG. 1;

FIG. 5 shows the device from FIG. 4 without the sliding contacts and the contact carriers that support them;

FIGS. 6 to 11 show various example embodiments of a separator of the device;

FIG. 12 shows a device according to the invention for transmitting electrical current to a rotor of an electric machine in a side view in a second example embodiment;

FIG. 13 shows the device in a sectional view along the line A-A;

FIG. 14 shows an enlarged section from FIG. 13; and

FIG. 15 shows a perspective side view of the device from FIG. 13.

### DETAILED DESCRIPTION

The figures show, by way of example, various views and embodiments of a device according to the disclosure for transmitting electrical current to a rotor of an electric machine.

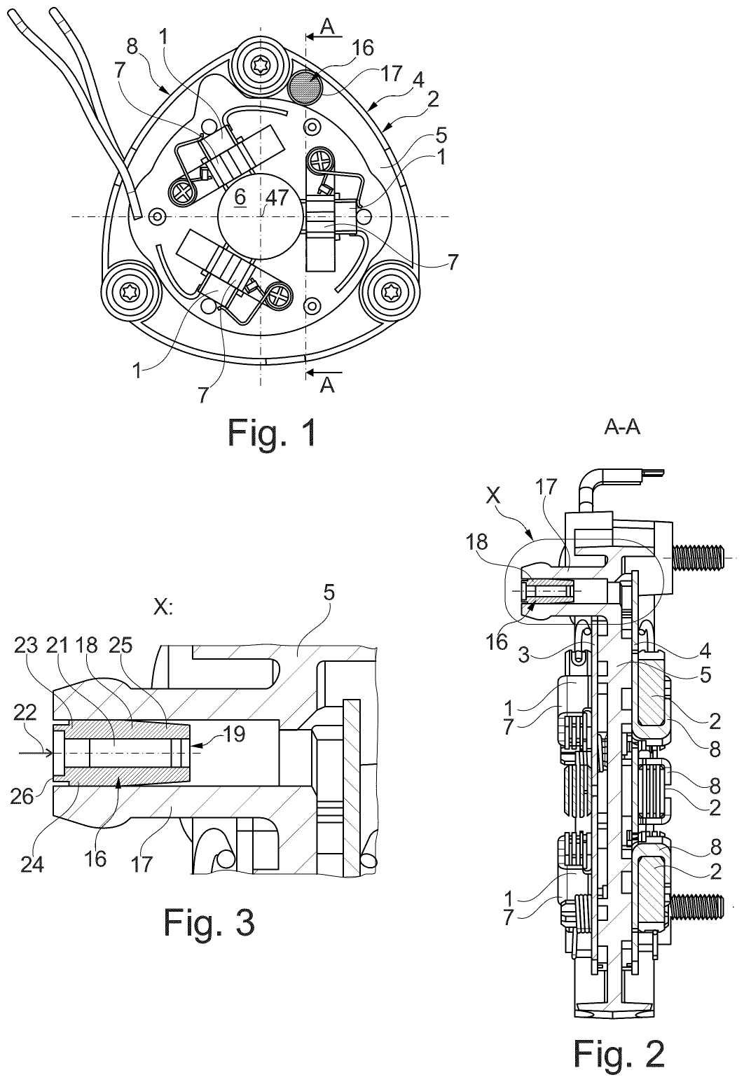

The device shown in FIGS. 1 to 5 in a first example embodiment comprises two groups, each with three sliding contacts 1, 2 assigned to an electrical pole for transmitting current to a slip ring of a rotor of the electric machine assigned to each such group. The sliding contacts 1, 2 can be designed as metal brushes, possibly made of brass or bronze, for engagement with the slip rings of the electric machine.

The groups of sliding contacts 1, 2 are arranged on two electrically conductive contact carriers 3, 4, which are supported by an electrically insulating base support 5 (FIGS. 1 to 5). The device can be fastened to a stationary component, for example a housing of the electric machine, via the base support 5, via screw connections. The contact carriers 3, 4 are made of electrically conductive metal and are each connected to an electrical power source, while the base support 5 also serves as an insulator and can be made of plastic.

The base support 5 and the contact carriers 3, 4 are each plate-shaped. The latter are fastened with the flat inner sides to the outer sides of the base support 5 via screw connections. The base support 5 and the contact carriers 3, 4 are each arranged radially inside with a central through-opening coaxially along the imaginary center axis 47 one behind the other. In this way, they form a through-hole 6 on the device, through which a rotor shaft of the electric machine, with slip rings arranged on the rotor shaft for transmitting current, can be guided axially into contact with the respectively assigned sliding contacts 1, 2 for transmitting current at the through-openings 6. The sliding contacts 1, 2 on the axial outer sides of the contact carriers 3, 4 are each arranged in holders 7, 8 and aligned directly with the through-opening 6.

A coolant system 9 with liquid cooling with a spray cooling of the sliding contacts 1, 2 is provided to cool the sliding contacts 1, 2 during operation (FIG. 2). Oil from the oil circuit of the electric machine can be used as the coolant.

For cooling purposes, a coolant channel 10, 11 is formed on each of the axial side surfaces of the base support 5, which is open in the axial direction and is covered on the open side by the respective adjacent contact carrier 3, 4 with the respective axial inner side thereof (FIGS. 1 and 3). In this process, the coolant is fed into a plurality of cooling loops 12, 13 of the respective coolant channel 10, 11, which are distributed over a large area and each assigned to a sliding contact 1, 2, in the region of the sliding contacts 1, 2 arranged on the outer sides of the contact carriers 3, 4.

The cooling loops 12, 13 each extend in an arc radially inwards towards the respective central through-opening 6 (FIG. 2). At the apex of each arc, at the point closest to the respective central through-opening 6, there is a spray opening 14, 15 which is directed directly at the respective sliding contacts 1, 2 and from which coolant can be sprayed from the respective coolant channel 10, 11 directly onto the sliding contacts.

According to FIGS. 1 to 5, a separator 16 is arranged in the coolant system 9 for separating, in particular, electrically conductive particles from the coolant flow. During operation, the electrically conductive particles enter the coolant as wear particles at the sliding contacts 1, 2 and are transported with the coolant flow as contamination into the coolant system 9. In order to avoid an increase in the electrical conductivity of the coolant due to the entrained electrically conductive particles, the particles are separated from the coolant at the separator 16. This ensures that operational disturbances caused in particular by electrical arcing between the sliding contacts and the respective slip ring as well as creepage currents between the electrical poles of the sliding contacts can be safely avoided.

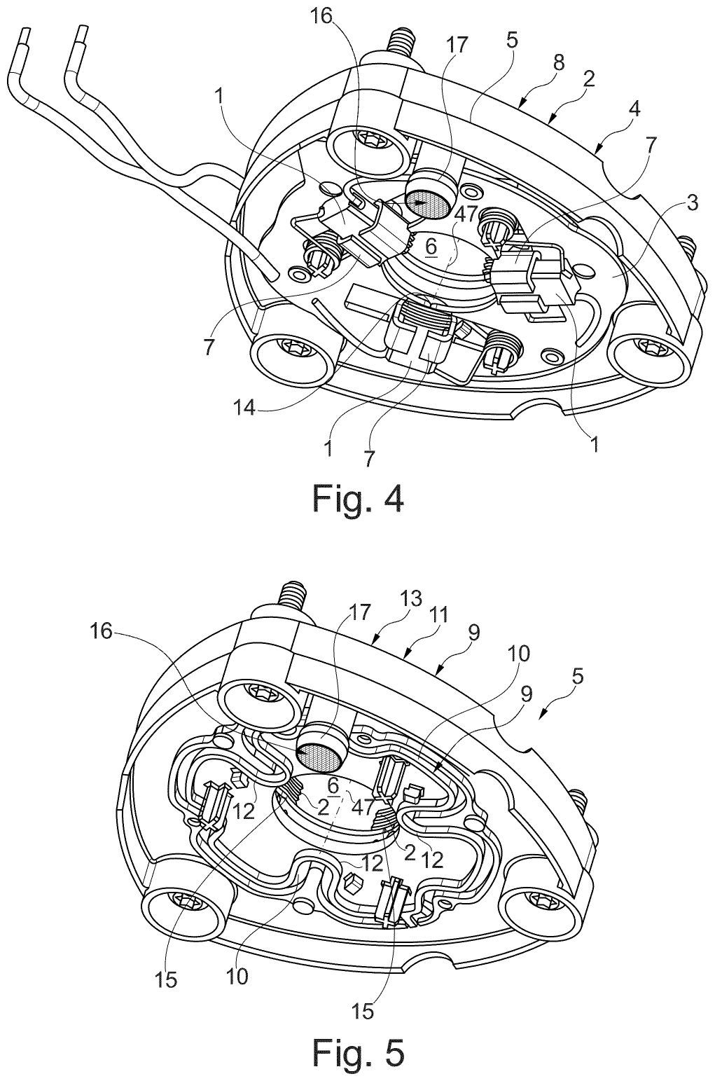

The separator 16 can be arranged in the coolant inlet 17 of the coolant system 9. The coolant inlet 17 is designed as a cylindrical coolant inlet nozzle, which is arranged axially protruding on one axial side of the base support 5. A filter is provided as the separator 16, which is pressed into place with a filter holder 18 directly in the area of the inlet opening of the coolant inlet nozzle 17 on the inner diameter thereof for fastening (FIGS. 4 to 6).

In addition to a filter surface 19 aligned in the flow direction of the coolant, the filter 16 has two additional filter surfaces 20, 21 aligned transversely to the flow direction. The flow direction is indicated by an arrow 22. The additional filter surfaces 20, 21 are arranged in a V-shape with the closed V-side in the flow direction (FIGS. 4 to 6). The filter surface 19, aligned in the flow direction, is formed on the closed V-side or V-base. The filter surfaces 19, 20, 21 merge smoothly into one another.

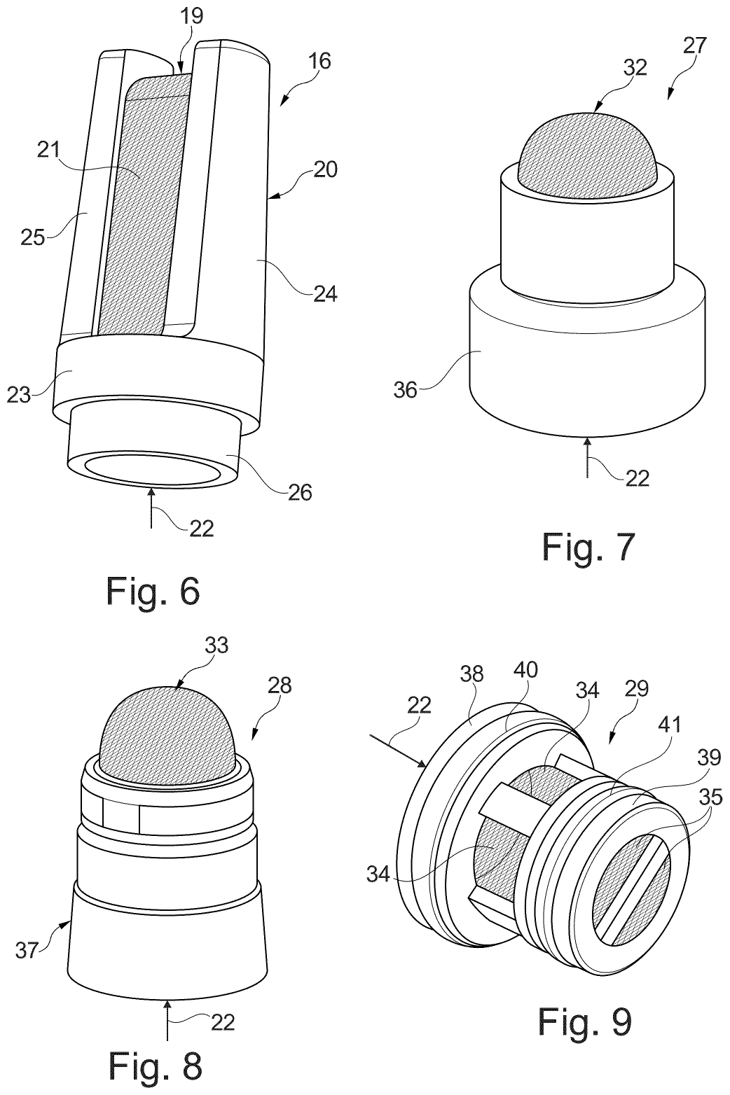

The filter holder 18 is designed with an annular fastening portion 23, potentially made of plastic, with which the filter 16 is pressed into the coolant inlet nozzle 16 on the base support 5. It is also possible to attach the parts using ultrasonic or laser welding. Two webs 24, 25 are connected to the fastening portion 23 in parallel to each other, between which the filter surfaces 19, 20, 21 with filter fabric are stretched. The webs 24, 25 taper towards the free end of the filter 16, which is aligned in the flow direction in the installed position (FIGS. 5 and 6). The filter inlet 26 is annularly offset radially inwards at the inlet end of the fastening portion 23.

The V-shaped arrangement of the filter surfaces 20, 21 increases the filter surface of the filter 15. At the same time, the V-shaped arrangement and the tapering of the filter holder at the webs 24, 25 create space in the coolant inlet nozzle 16 for the outflow of the coolant escaping at the filter surfaces 20, 21. In this way, the pressure loss at the filter 16 can be reduced with the same coolant flow rate or the coolant flow rate can be increased while maintaining the same pressure loss.

The further embodiments of a separator 27 to 31 shown as examples in FIGS. 7 to 12 are designed as filters and can be fastened in the coolant system 9, in particular in the coolant inlet 17, in particular by pressing in or ultrasonic or laser welding.

FIGS. 7 to 9 show designs of filters 27, 28, 29 in which a lateral flow through the filter surfaces 32, 33, 34 is made possible. In the example embodiments according to FIGS. 7 and 8, a filter surface 32, 33 protruding in a convex manner is provided at the free end of the filter 27, 28 aligned in the flow direction 22. In the embodiment according to FIG. 9, a plurality of filter surfaces 34 are arranged distributed over the circumference and aligned transversely to the flow direction 22, and two filter surfaces 35 aligned in the flow direction 22 are formed at the free end.

The design according to FIG. 7 has a metal annular fastening portion 36, while in the embodiment according to FIG. 8 a fastening portion 37 made of plastic is provided. The latter consists of a conical section on the inlet side and a cylindrical section that follows seamlessly from this. In both of the above-mentioned embodiments, a cylindrical section made of plastic is formed which adjoins the respective fastening portion 36, 37 and is offset radially inwards, to which the respective filter surface 32, 33 is fastened.

The filter 29 shown in FIG. 9 has two fastening portions 38, 39 with different diameters, wherein the fastening portion 39 with the smaller diameter forms the filter end aligned in the flow direction 22 with two filter surfaces 35 aligned on the end face in the flow direction 22. On the outer diameter of the respective fastening portion 38, 39, a sealing ring 40, 41 is received in a ring groove. Filter surfaces 34 aligned transversely to the flow direction 22 are arranged between the fastening portions 38, 39 and are fastened to the latter and to the webs connecting them.

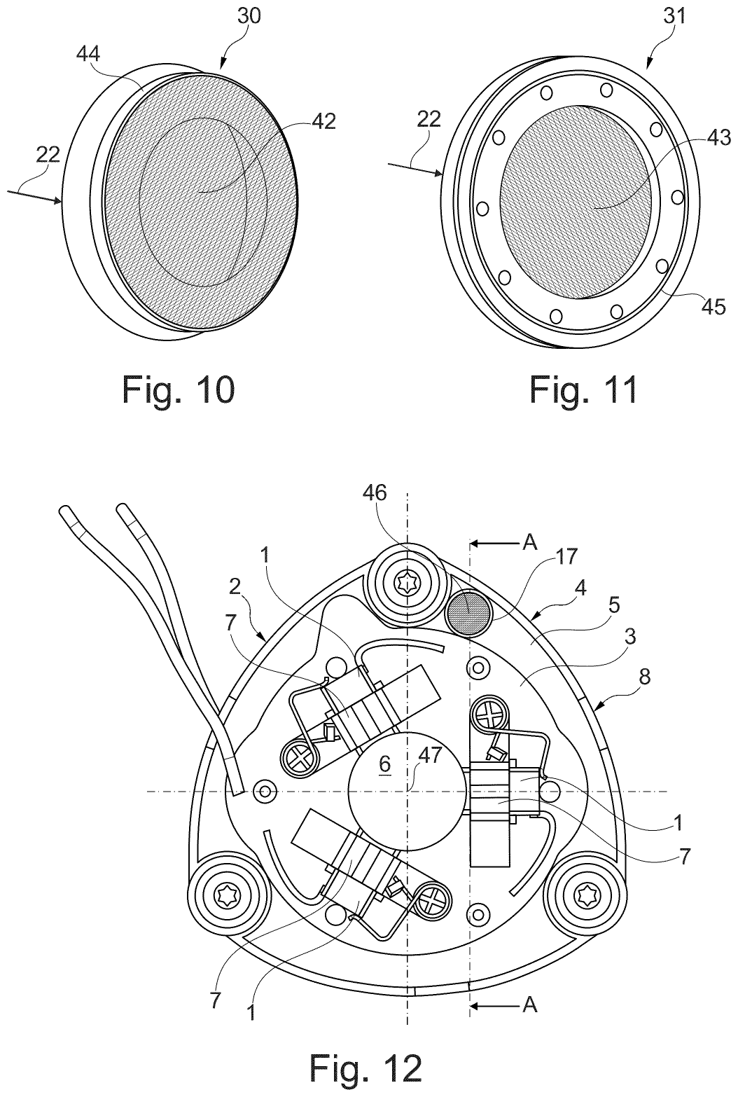

FIGS. 10 and 11 show two disc-shaped filters 30, 31, each with a filter surface 42, 43 aligned in the flow direction 22, which are fixed in a filter holder 44, 45 made of plastic.

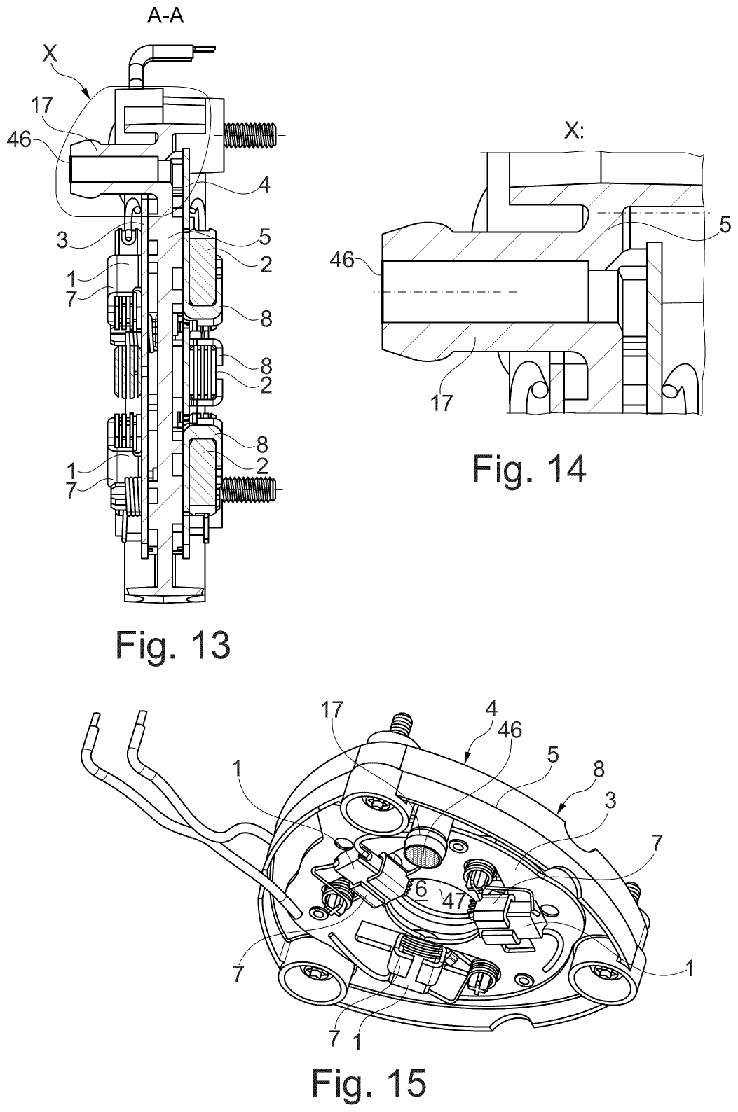

In an example embodiment of a device for transmitting electrical current to a rotor of an electric machine shown in FIGS. 13 to 16, a filter fabric is arranged as a separator 46 and is fastened directly in the coolant inlet nozzle 17 of the coolant system 9 on the base support 5. The filter fabric 46 spans the entire flow cross-section of the coolant inlet nozzle 17 and is fastened directly in the area of the inlet opening of the coolant inlet nozzle 17 to the inner diameter of the same, via, in an example embodiment, ultrasonic or laser welding. This design eliminates the need for additional fastening components and reduces the installation space required for the separator 46. In addition, the filter surface formed by the filter fabric 46 in the flow direction can be enlarged over the entire flow cross-section of the coolant inlet nozzle 17. For further details, please refer to the preceding description of FIGS. 1 to 5.

The contact carriers 3, 4, each fastened to the base support 5, form with said base support a pre-assembled modular unit that can be easily mounted on the electric machine (FIGS. 1, 2, 4, 5, 13 and 15).

Due to the design of the base support 5, particularly in plastic, the device can be easily adapted to the individual installation conditions, in particular to the rotor shaft of the electric machine.

In this way, the proposed device can be manufactured as a prefabricated module with flexible design and construction as a standardized, cost-saving design with identical or largely identical and few components in particularly cost-effective series production. This applies in particular to the contact carriers 3, 4 with the sliding contacts 1, 2 fastened thereto.

### LIST OF REFERENCE SYMBOLS

1 Sliding contact
2 Sliding contact
3 Contact carrier
4 Contact carrier
5 Base support
6 Through-hole, through-opening
7 Holder
8 Holder
9 Coolant system
10 Coolant channel
11 Coolant channel
12 Cooling loop
13 Cooling loop
14 Spray opening
15 Spray opening
16 Separator, filter
17 Coolant inlet, coolant inlet nozzle
18 Filter holder
19 Filter surface
20 Filter surface
21 Filter surface
22 Flow direction
23 Fastening portion
24 Web
25 Web
26 Filter inlet
27 Separator, filter
28 Separator, filter
29 Separator, filter
30 Separator, filter
31 Separator, filter
32 Filter surface
33 Filter surface
34 Filter surface
35 Filter surface
36 Fastening portion
37 Fastening portion
38 Fastening portion
39 Fastening portion
40 Sealing ring
41 Sealing ring
42 Filter surface
43 Filter surface
44 Filter holder
45 Filter holder
46 Separator, filter fabric
47 Imaginary axis

1. A device for transmitting electrical current to a rotor of an electric machine, the device comprising:
a group of sliding contacts, each one of the group of sliding contacts corresponding to an electrical pole for transmitting current to a slip ring of the electric machine,
at least one filter configured for filtering electrically conductive particles from a liquid coolant of a coolant system configured for cooling the group of sliding contacts, the at least one filter arranged in a region of a coolant inlet of the coolant system, and
the group of sliding contacts, the coolant system, and the coolant inlet are arranged on a base support.

2. The device according to claim 1, wherein the filter is pressed into a coolant inlet nozzle of the coolant inlet of the coolant system for fastening via a filter holder.

3. The device according to claim 2, wherein the filter further comprises a filter surface aligned in a flow direction of the liquid coolant, and at least one additional filter surface aligned transversely to the flow direction of the liquid coolant.

4. The device according to claim 3, wherein the filter comprises two additional filter surfaces which are aligned transversely to the flow direction and are arranged in a V-shape with a closed V-side facing in the flow direction.

5. The device according to claim 1, wherein a filter fabric of the filter is fastened directly in a coolant inlet nozzle of the coolant system.

6. The device according to claim 5, wherein the filter fabric is fastened in the coolant inlet nozzle by ultrasonic or laser welding.

7. The device according to claim 2, wherein the filter holder is constructed from a plastic material.

8. The device according to claim 5, wherein the coolant inlet nozzle is constructed from a plastic material.

9. The device according to claim 1, wherein the base support further comprises a central through-opening configured to receive a rotor shaft of the electric machine.

10. The device according to claim 9, wherein the base support further comprises a first electrically current-conducting contact carrier arranged on a first side of the base support, and a second electrically current-conducting contact carrier arranged on a second side of the base support, and the group of sliding contacts is fastened to each of the first electrically current-conducting contact carrier and the second electrically current-conducting contact carrier.

11. The device according to claim 10, wherein the group of sliding contacts comprises a first group of sliding contacts and a second group of sliding contacts, and a first electrically current-conducting contact carrier arranged on a first side of the base support is fastened to the first group of sliding contacts, and a second electrically current conducting contact carrier arranged on a second side of the base support is fastened to the second group of sliding contacts.

12. A device for transmitting electrical current to a rotor of an electric machine, the device comprising:
a plurality of sliding contacts configured for transmitting current to a slip ring of a rotor shaft of the electric machine,
a coolant system configured for cooling the plurality of sliding contacts,
at least one filter configured for filtering electrically conductive particles from a liquid coolant of the coolant system, the filter fixed to an inlet of the coolant system, and
the plurality of sliding contacts, the coolant system, and the inlet of the coolant system are arranged on a base support.

13. The device according to claim 12, wherein the coolant system further comprises a coolant channel arranged on the base support.

14. The device according to claim 13, wherein the coolant channel is integral with the base support.

15. The device according to claim 13, wherein the base support further comprises a through-opening configured to receive a rotor shaft of the electric machine.

16. The device according to claim 15, further comprising a contact carrier fastened to at least a portion of the plurality of sliding contacts, the coolant channel arranged between the contact carrier and the base support in an axial direction relative to the through-opening.

17. A device for transmitting electrical current to a rotor of an electric machine, the device comprising:
a base support comprising:
on a first side:
a first plurality of sliding contacts configured for transmitting current to a slip ring of a rotor shaft of the electric machine, and
a first coolant channel of a coolant system configured for cooling the first plurality of sliding contacts,
on a second side:
a second plurality of sliding contacts configured for transmitting current to a slip ring of the rotor shaft of the electric machine, and
a second coolant channel of the coolant system configured for cooling the second plurality of sliding contacts,
a filter fixed to an inlet of the coolant system, the filter configured to remove electrically conductive particles from coolant of the coolant system.

18. The device according to claim 17, further comprising:
a first contact carrier arranged on the first side of the base support, the first contact carrier fixed to the first plurality of sliding contacts,
a second contact carrier arranged on a second side of the base support, the second contact carrier fixed to the second plurality of sliding contacts.

19. The device according to claim 18, wherein the base support further comprises a through-opening configured to receive a rotor shaft of the electric machine.

20. The device according to claim 19, wherein the inlet of the coolant system extends parallel to an axis of the through-opening.
